(19) United States
(12) Patent Application Publication
(10) Pub. No.: US 2026/0008364 A1
(43) Pub. Date: Jan. 8, 2026

(54) NON-INSULATED CHARGER FOR REDUCING LEAKAGE CURRENT AND METHOD OF GENERATING EQUIVALENT CIRCUIT THEREOF

(71) Applicants: Hyundai Motor Company, Seoul (KR); Kia Corporation, Seoul (KR); Incheon University Industry Academic Cooperation Foundation, Incheon (KR)

(72) Inventors: Tae-Hwan Kim, Hwaseong-si (KR); Ji-Han Lee, Hwaseong-si (KR); Youn-Sik Lee, Hwaseong-si (KR); Dae-Woo Lee, Hwaseong-si (KR); Ki-Sang Lee, Hwaseong-si (KR); Seok-Min Hong, Uiwang-si (KR); Jae-Bum Lee, Uiwang-si (KR); Dong-In Lee, Incheon (KR); Han-Shin Youn, Incheon (KR)

(21) Appl. No.: 18/956,279

(22) Filed: Nov. 22, 2024

(30) Foreign Application Priority Data
Jul. 3, 2024 (KR) 10-2024-0087461

(51) Int. Cl. B60L 53/22; H02M 1/12; H02M 1/42

(52) U.S. Cl. CPC B60L 53/22; H02M 1/123; H02M 1/4233; H02M 1/4241; B60L 2210/30; B60L 2240/527

(57) ABSTRACT

A non-insulated charger can be capable of reducing a common mode leakage current of the non-insulated charger, and the non-insulated charger can include a filter configured to remove interference electromagnetic waves from an AC voltage, a power factor adjustment circuit configured to reduce power loss through power factor adjustment with respect to the AC voltage from which the interference electromagnetic waves have been removed and convert the AC voltage into a first DC voltage, and a converter configured to convert the first DC voltage into a second DC voltage differing from the first DC voltage and having a circuit structure in which both an input side and an output side have a form of a full bridge to reduce a common mode leakage current.

### CROSS-REFERENCE TO RELATED APPLICATIONS

This application claims the priority and benefit of Korean Patent Application No. 10-2024-0087461, filed on Jul. 3, 2024, which application is hereby incorporated herein by reference in its entirety.

### TECHNICAL FIELD

The present disclosure relates to a non-insulated charger.

### BACKGROUND

A vehicle-mounted charger is generally composed of a power factor correlation (PFC) stage and an insulated direct current/direct current (DC/DC) stage. A transformer of the insulated DC/DC stage causes power loss in a battery charging process, which is a limiting factor in reducing a charging time. Furthermore, the transformer together with an electrolytic capacitor has a large volume in the vehicle-mounted charger and thus is a disadvantageous element in terms of a reduction in volume.

It is necessary to improve marketability through the development and installation of a transformer-less non-insulated vehicle-mounted charger. In general, such a non-insulated vehicle-mounted charger has advantages of increased efficiency and reduced volume, but has a problem of generating a large common mode leakage current compared to an insulated charger.

In addition, in the case of a non-insulated vehicle-mounted charger, a ‘PFC and DC/DC primary side’ and a ‘DC/DC secondary side and high-voltage battery’ are not electrically separated due to the removal of the transformer. Therefore, a Y-capacitor of a ‘DC/DC output side and battery’ is projected onto the ‘PFC and DC/DC primary side.’ That is, a Y-capacitor voltage of the ‘DC/DC output side and HV battery’ fluctuates under the influence of the PFC stage to generate a common mode leakage current at an AC input terminal of the vehicle-mounted charger.

Electric vehicle supply equipment (EVSE) or a leakage circuit breaker constantly detects the common mode leakage current generated from the vehicle-mounted charger.

At this time, when the common mode leakage current of a predetermined level or more is detected, the EVSE or leakage circuit breaker cuts off the power supply to stop the battery charging of an electric vehicle. According to NFPA 70, National Electrical Code (NEC) 208.8, a ground fault circuit interrupter (GFCI) is applied to bathrooms, garages, etc. In this case, the leakage current is limited to about 5 mA based on the UL943 standard Class A.

Therefore, the reduction in the common mode leakage current is essential for the development and/or application of the non-isolated vehicle-mounted charger.

Generally, in studies of non-isolated vehicle-mounted chargers, a bridgeless PFC circuit is applied to the PFC stage, and a buck converter is applied to the DC/DC stage. That is, although the buck converter is mainly applied to a step-down converter, there is a problem that a large common mode leakage current is generated.

That is, in a common mode equivalent model, the Y-capacitor at an output side of the buck converter is projected onto the PFC stage. That is, the PFC Y-capacitor and the buck Y-capacitor are connected in parallel. In addition, voltages at both ends of the PFC converter Y-capacitor and the buck Y-capacitor fluctuate together to generate the common mode leakage current.

At this time, as the capacitance of the Y-capacitor at the output side of the buck converter becomes several hundred nF to several μF, the magnitude of the common mode leakage current is very large.

A large leakage current causes a leakage current blocking operation of the GFCI or EVSE. Because this causes a situation in which the high-voltage battery cannot be charged, a DC/DC converter having a different structure rather than a simple buck converter and a non-isolated charger circuit structure are required.

### SUMMARY

The present disclosure relates to a non-insulated charger, and more specifically, to a non-insulated charger and a method of generating an equivalent circuit thereof, which can be capable of reducing a common mode leakage current.

An embodiment of the present disclosure can solve the above problems and can provide a non-insulated charger and a method of generating an equivalent circuit thereof, which can be capable of reducing a common mode leakage current of the non-insulated charger.

An embodiment of the present disclosure can provide a non-insulated charger and a method of generating an equivalent circuit thereof, which can be capable of applying a general step-down converter to a direct current/direct current (DC/DC) stage of the non-insulated charger.

An embodiment of the present disclosure can provide a non-insulated charger capable of reducing a common mode leakage current of the non-insulated charger.

A non-insulated charger can include a filter configured to remove interference electromagnetic waves from an AC voltage, a power factor adjustment circuit configured to reduce power loss through power factor adjustment with respect to the AC voltage from which the interference electromagnetic waves have been removed and convert the AC voltage into a first DC voltage, and a converter configured to convert the first DC voltage into a second DC voltage differing from the first DC voltage and having a circuit structure in which both an input side and an output side have a form of a full bridge to reduce a common mode leakage current.

According to an embodiment of the present disclosure, a method of generating an equivalent circuit of a non-insulated charger can include dividing a circuit structure in the form of a full bridge into a common mode voltage source and a differential mode voltage source based on a switching operation and marking the divided circuit structure in an original circuit diagram composed of a filter configured to remove interference electromagnetic waves from an AC voltage, a power factor adjustment circuit configured to reduce power loss through power factor adjustment with respect to the AC voltage from which the interference electromagnetic waves have been removed and convert the AC voltage into a first DC voltage, and a converter configured to convert the first DC voltage into a second DC voltage differing from the first DC voltage and having a circuit structure in which both an input side and an output side have a form of a full bridge to reduce a common mode leakage current by a microprocessor, shorting, by the microprocessor, the differential mode voltage source, and integrating, by the microprocessor, elements in series and parallel and organizing the elements into a common mode equivalent circuit corresponding to the original circuit diagram.

Using an embodiment of the present disclosure, it can be possible to secure the reduction performance of the high leakage current compared to the conventional PFC and buck type non-insulated chargers.

Using an embodiment of the present disclosure, there can be the high possibility of preventing the causes of the leakage current blocking operation of the GFCI and/or EVSE when the high-voltage battery is charged.

Using an embodiment of the present disclosure, it can be possible to enable the high-frequency operation of the DC/DC stage and reduce the volume of the element based on the application of the resonant topology.

### BRIEF DESCRIPTION OF THE DRAWINGS

FIG. 1 is a conceptual diagram of a vehicle charging system having a charger for reducing a leakage current according to an embodiment of the present disclosure.

FIG. 2 is a circuit diagram of a filter shown in FIG. 1, according to an embodiment of the present disclosure.

FIG. 3 is a circuit diagram of a power factor adjustment circuit shown in FIG. 1, according to an embodiment of the present disclosure.

FIG. 4 is a circuit diagram of a converter shown in FIG. 1, according to an embodiment of the present disclosure.

FIG. 5A is a flowchart showing a process of generating a common mode equivalent circuit according to an embodiment of the present disclosure.

FIG. 5B is a flowchart showing a detailed process of an operation of separately indicating voltage sources shown in FIG. 5A, according to an embodiment of the present disclosure.

FIG. 5C is a flowchart showing a detailed process of an operation of integrating the voltage sources shown in FIG. 5A in series and parallel, according to an embodiment of the present disclosure.

FIGS. 6A to 6H are circuit diagrams showing a process of changing all circuit diagrams according to FIGS. 2 to 4 into equivalent circuits, according to an embodiment of the present disclosure.

FIG. 7 is an equivalent circuit diagram for all circuit diagrams according to FIGS. 2 to 4, according to an embodiment of the present disclosure.

FIG. 8 is a diagram showing the impedance of the equivalent circuit shown in FIG. 7, according to an embodiment of the present disclosure.

FIG. 9 is a transfer function bode plot according to an embodiment of the present disclosure.

FIG. 10 is a simulation waveform diagram of a non-insulated charger according to an embodiment of the present disclosure.

### DETAILED DESCRIPTION OF ILLUSTRATIVE EMBODIMENTS

The above-described features and advantages of example embodiments of the present disclosure will be described below in detail with reference to the accompanying drawings, and thus those skilled in the art to which the present disclosure pertains can be able to easily carry out the technical spirit of the present disclosure. In describing example embodiments of the present disclosure, when it is determined that a detailed description of the known technology related to the present disclosure may unnecessarily obscure the gist of the present disclosure, a detailed description thereof can be omitted.

Hereinafter, example embodiments of the present disclosure will be described in detail with reference to the accompanying drawings. In the drawings, same reference numerals can be used to denote same or similar components.

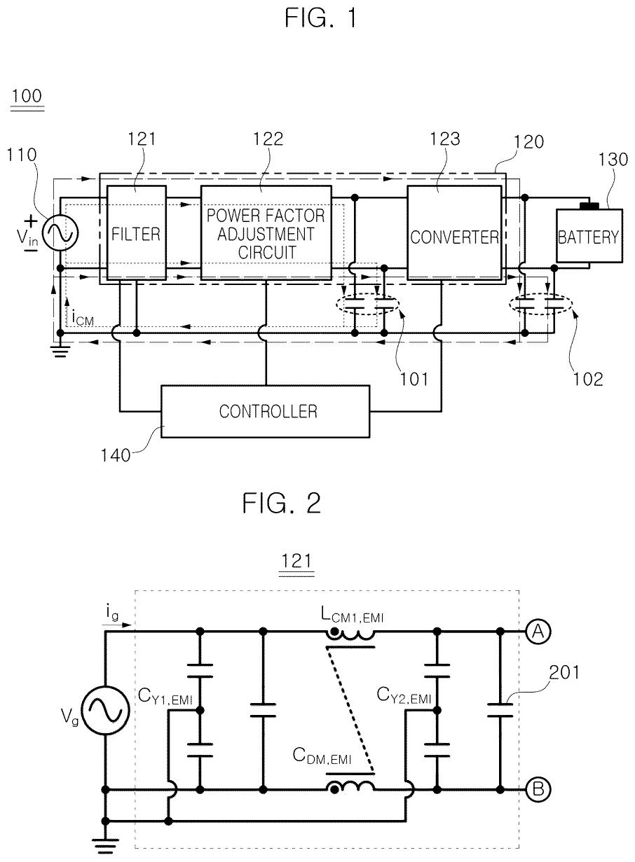

FIG. 1 is a conceptual diagram of a vehicle charging system 100 having a charger 120 for reducing a leakage current according to an embodiment of the present disclosure. Referring to FIG. 1, a charging system 100 may include a charger 120 for receiving and converting an AC voltage from an external AC voltage source 110 into a DC voltage, a battery 130 for charging the DC voltage, a controller 140 for controlling the charger 120, etc.

The charger 120 may include a filter 121 for removing interference electromagnetic waves from the AC voltage source Vᵢₙ, a power factor adjustment circuit 122 for converting the AC voltage into the DC voltage and adjusting the loss generated in the process, a converter 123 for increasing or decreasing the DC voltage, etc.

The filter 121 can perform the function of removing interference electromagnetic waves from the AC voltage source Vᵢₙ. The interference electromagnetic waves may include electromagnetic interference (EMI). The types of EMI may include conducted emission and radiated emission.

The power factor adjustment circuit can function to convert the AC voltage, from which the interference electromagnetic waves have been removed, into the DC voltage and reduce the loss of the power that occurs in such a conversion process. That is, the power factor adjustment circuit 122 can have an inverter configuration that can function to convert an AC voltage into a DC voltage and a configuration that can improve a power factor. That is, the power factor adjustment circuit 122 may be an inverter type PFC.

The converter 123 can function to perform a function of increasing or decreasing the DC voltage. The converter 123 may be a DC-DC converter.

The battery 130 can include battery cells (not shown) configured in series and/or parallel, and the battery cells may be high-voltage battery cells for electric vehicles, such as nickel metal battery cells, lithium ion battery cells, lithium polymer battery cells, lithium sulfur battery cells, sodium sulfur battery cells, and all-solid-state battery cells, for example.

In general, a high-voltage battery can indicate a battery used as a power source for moving electric vehicles and has a high voltage of 100 V or more. However, the present disclosure is not necessarily limited thereto, and low-voltage batteries can be also possible.

The controller 140 can function to control the power factor adjustment circuit 122, the converter 123, etc. In particular, the controller 140 can perform switching control to control a switching operation for the power factor adjustment circuit 122 to reduce a common mode leakage current. The controller 140 may include a microprocessor, a microcomputer, a modulation drive circuit for generating a modulation signal for switching, etc. The modulation signal may be pulse width modulation (PWM), pulse frequency modulation (PFM), etc., for example.

A first output capacitor 101 and/or a second output capacitor 102 can be Y=Y capacitors and can be connected to the ground GND and output sides of the power factor adjustment circuit 122/converter 123. In such case, a large common mode leakage current i_{CM} can be generated. To reduce the common mode leakage current i_{CM}, the controller 140 may perform switching control on the power factor adjustment circuit 122.

The first output capacitor 101 and/or the second output capacitor 102 can function as a path for the common mode leakage current i_{CM}. Therefore, the common mode leakage current i_{CM} can be discharged to the ground GND through the first output capacitor 101 and/or the second output capacitor 102.

FIG. 2 is a circuit diagram of a filter 121 shown in FIG. 1. Referring to FIG. 2, to filter the interference electromagnetic waves from a grid current i_{g} introduced from a grid voltage V_{g}, the filter 121 may be composed of two first Y-capacitors C_{Y1,EMI} for filtering electromagnetic waves, which are connected in series, a differential mode (DM)-capacitor C_{DM,EMI} for filtering electromagnetic waves, which is connected parallel to the first Y-capacitor C_{Y1,EMI} for filtering electromagnetic waves, a first common mode (CM)-transformer element L_{CM1,EMI} for filtering electromagnetic waves, which is connected parallel to the differential-capacitor C_{DM,EMI} for filtering electromagnetic waves, a second Y-capacitor C_{Y2,EMI} for filtering electromagnetic waves, which is connected parallel to the first common mode-transformer element L_{CM1,EMI} for filtering electromagnetic waves, etc.

The grid voltage V_{g} can be a voltage supplied from an AC input power grid, which can be the same as the external AC voltage source 110 shown in FIG. 1, and is usually an AC voltage of about 220 V in some countries. In such case, a grid frequency can be about 60 Hz, and considering a fluctuation range, can range from about 50 to 70 Hz.

The second Y-capacitor C_{Y2,EMI} for filtering electromagnetic waves may be composed of two Y-capacitors C_{Y2,EMI} connected in series in FIG. 2 and a capacitor 201 connected parallel to the two Y-capacitors C_{Y2,EMI}, but is not necessarily limited thereto.

The transformer element L_{CM1,EMI} can be an element in which two conductors are wound around one magnet and can have the same shape as a transformer. Therefore, “Z” indicates a state in which the two conductors are wound around one magnet.

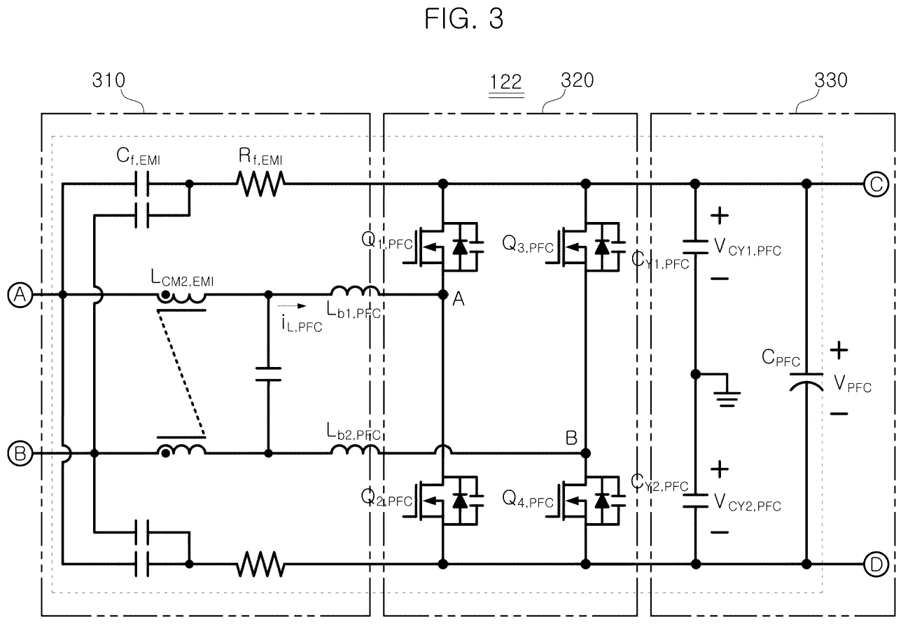

FIG. 3 is a circuit diagram of the power factor adjustment circuit 122 shown in FIG. 1. Referring to FIG. 3, the power factor adjustment circuit 122 may include a boost unit 310, a switching unit 320, an output unit 330, etc.

The boost unit 310 can include the second CM-transformer element L_{CM2,EMI} for filtering electromagnetic waves, which is connected to an output terminal of the filter 121, two floating capacitors C_{f,EMI} for filtering electromagnetic waves, which are connected parallel to the output terminal of the filter 121, a resistor R_{f,EMI} for an electromagnetic wave line filter, which is connected to the floating capacitors C_{f,EMI} for filtering electromagnetic waves, a capacitor 301 connected parallel to the CM-transformer element L_{CM2,EMI} for filtering electromagnetic waves, and first and second boost inductors L_{b1,PFC} and L_{b2,PFC} connected parallel to the capacitor 301.

The floating capacitor C_{f,EMI} for filtering electromagnetic waves and the resistor R_{f,EMI} for an electromagnetic wave line filter function to prevent a current path from being suddenly cut off when the switching unit 320 can be turned off, thereby preventing the generation of a high voltage.

A capacitor can be connected parallel to the second CM-transformer element L_{CM2,EMI} for filtering electromagnetic waves. A PFC current i_{L1,PFC} flows through the boosting inductor L_{b1,PFC}.

The switching unit 320 can be connected to output terminals of the first and second boost inductors L_{b1,PFC} and L_{b2,PFC} in the form of a single-phase full bridge. That is, the first boost inductor L_{b1,PFC} can be connected to a first neutral point A of a first switching element Q_{1,PFC} and a second switching element Q_{2,PFC} of the switching unit 320, and the second boost inductor L_{b2,PFC} can be connected to a second neutral point B of a third switching element Q_{3,PFC} and a fourth switching element Q_{4,PFC} of the switching unit 320.

As the first to fourth switching elements Q_{1,PFC} to Q_{4,PFC}, a power metal oxide silicon field effect transistor (MOSFET) can be mainly used, but a field effect transistor (FET), an insulated gate bipolar mode transistor (IGBT), etc. may also be used. The first to fourth switching elements Q_{1,PFC} to Q_{4,PFC} can include anti-parallel diodes. An output capacitor voltage of the output capacitor 101 increases through the conduction of the anti-parallel diode.

The output unit 330 can include an upper Y-capacitor C_{Y1,PFC} and a lower Y-capacitor C_{Y2,PFC} disposed in series at the output terminal of the switching unit 320. An output capacitor C_{PFC} can be connected parallel to the upper Y-capacitor C_{Y1,PFC} and the lower Y-capacitor C_{Y2,PFC}.

That is, the first to fourth switching elements Q_{1,PFC} to Q_{4,PFC} can be driven in a unipolar inverter PWM manner. Through such a switching operation, the PFC operation can be performed, and a constant DC voltage V_{PFC} can be generated at the output capacitor C_{PFC}.

An upper voltage V_{CY1,PFC} can be generated at the upper Y-capacitor C_{Y1,PFC}, and a lower voltage V_{CY2,PFC} can be generated at the lower Y-capacitor C_{Y2,PFC}. The voltage V_{PFC} of the output capacitor C_{PFC} can be the sum of the upper voltage V_{CY1,PFC} and the lower voltage V_{CY2,PFC}. However, the upper voltage V_{CY1,PFC} and the lower voltage V_{CY2,PFC} can be not the same due to a common mode current and may be represented as follows in Equations 1 and 2.

$${V}_{{CY}_{1} , PFC} = 0.5 {V}_{PFC} + 0.5 {V}_{g} \qquad Equation 1$$

$${V}_{{CY}_{2} , PFC} = 0.5 {V}_{PFC} + 0.5 {V}_{g} \qquad Equation 2$$

The midpoint of the upper Y-capacitor C_{Y1,PFC} and the lower Y-capacitor C_{Y2,PFC} can be connected to the ground GND. That is, it can become a Y-capacitor structure.

The upper Y-capacitor C_{Y1,PFC} and the lower Y-capacitor C_{Y2,PFC} can be non-polar capacitors, and the output capacitor C_{PFC} can be a polar capacitor. Therefore, the upper Y-capacitor C_{Y1,PFC} and the lower Y-capacitor C_{Y2,PFC} can function to temporarily store electricity.

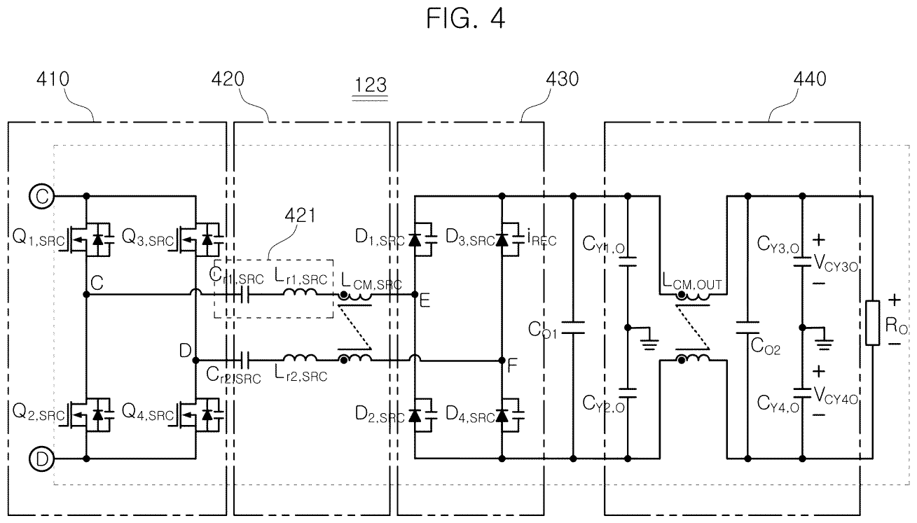

FIG. 4 is a circuit diagram of the converter 123 shown in FIG. 1. Referring to FIG. 4, the converter 123 may include an input side full bridge 410, a resonant transformer 420, an output side full bridge 430, an output filter unit 440, etc.

The input side full bridge 410 can be connected to the output terminal of the power factor adjustment circuit 122 to convert a DC voltage into an AC voltage. The input side full bridge 410 can be composed of four switching elements Q_{1,SRC}, Q_{2,SRC}, Q_{3,SRC}, and Q_{4,SRC}.

A third neutral point C between the first switching element Q_{1,SRC} and the second switching element Q_{2,SRC} and a fourth neutral point D between the third switching element Q_{3,SRC} and the fourth switching element Q_{4,SRC} can be connected to the resonant transformer 420.

The resonant transformer 420 can be composed of a first resonant transformer path C_{r1,SRC}, L_{r1,SRC}, and L_{CM,SRC} and a second resonant transformer path C_{r2,SRC}, L_{2,SRC}, L_{CM,SRC} and can transform a high voltage into a low voltage while performing a resonant operation. The first resonant transformer path C_{r1,SRC}, L_{r1,SRC}, and L_{CM,SRC} can be connected to the third neutral point C, and the second resonant transformer path C_{r2,SRC}, L_{2,SRC}, L_{CM,SRC} can be connected to the fourth neutral point D.

That is, a first resonant capacitor C_{r1,SRC} for a series resonant converter (SRC) and a first resonant inductor L_{r1,SRC} for an SRC can be connected in series to perform a resonant operation and at the same time, perform a transformer operation according to a switching frequency of the input side full bridge 410. That is, the first resonant capacitor C_{r1,SRC} for an SRC and the first resonant inductor L_{r1,SRC} for an SRC can be connected to form a resonant circuit 421. The first resonant capacitor C_{r1,SRC} for an SRC can be directly connected to the third neutral point C (i.e., a leg), and the second resonant capacitor C_{r2,SRC} for an SRC can be directly connected to the fourth neutral point D (i.e., a leg).

A second resonant capacitor C_{r2,SRC} for an SRC and a second resonant inductor L_{r2,SRC} for an SRC can perform a resonant operation and at the same time, perform a transformer operation according to the switching frequency of the input side full bridge 410.

Describing the operation process of the resonant transformer 420, the first resonant capacitor C_{r1,SRC} for an SRC and the first resonant inductor L_{r,SRC} for an SRC can perform the resonant operation to generate an AC resonant current. When the switching frequency of the input side full bridge 410 is the same as the resonant frequencies of the first resonant capacitor C_{r1,SRC} for an SRC and the first resonant inductor L_{r1,SRC} for an SRC, output voltages of the output side full bridge 430 and the output filter unit 440 can be the same as the input voltage of the input side full bridge 410.

However, the greater a difference between the switching frequency of the input side full bridge 410 and the resonant frequency of the first resonant capacitor C_{r1,SRC} for an SRC and the first resonant inductor L_{r1,SRC} for an SRC, the lower the output voltage. That is, regardless of whether the switching frequency increases or decreases, the greater the difference from the resonant frequency, the lower the output voltage.

That is, the resonant transformer 420 can perform transformation as much as a degree corresponding to the difference between the switching frequency of the input side full bridge 410 and the resonant frequency of the first resonant capacitor C_{r1,SRC} for an SRC and the first resonant inductor L_{r1,SRC} for an SRC. Through such an operation, the resonant transformer 420 can transmit the resonant current to the output side full bridge 430 or perform transformation.

Referring to the circuit shown in FIG. 4, resonant parameters may be calculated as follows in Equations 3 and 4.

$${C}_{r 1 , SRC} = {C}_{r 2 , SRC} \qquad [ Equation 3 ]$$

$${C}_{r , SRC} = \frac{{C}_{r 1 , SRC} {C}_{r 2 , SRC}}{{C}_{r 1 , SRC} + {C}_{r 2 , SRC}}$$

$${L}_{r 1 , SRC} = {L}_{r 2 , SRC} \qquad [ Equation 4 ]$$

$$\frac{{L}_{r 1 , SRC} = {L}_{r 2 , SRC}}{{L}_{r , SRC} = {L}_{r 2 , SRC} + {L}_{r 2 , SRC}}$$

In an embodiment of the present disclosure, the converter 123 can be a series resonant converter without a transformer and magnetizing inductance. The output side full bridge 430 can be connected to the output terminal of the resonant transformer 420 to perform a rectifying function of converting an AC current into a DC current. The output side full bridge 430 can be composed of four switching elements D_{1,SRC}, D_{2,SRC}, D_{3,SRC}, and D_{4,SRC}.

The first resonant transformation path C_{r1,SRC}, L_{r1,SRC}, and L_{CM,SRC} of the resonant transformer 420 can be connected to a fifth neutral point E between the first switching element D_{1,SRC} and the second switching element D_{2,SRC}, and a sixth neutral point F between the third switching element D_{3,SRC} and the fourth switching element D_{4,SRC} can be connected to the second resonant transformation path C_{r2,SRC}, L_{2,SRC}, and L_{CM,SRC} of the resonant transformer 420.

The transformer element L_{CM,SRC} can perform a common mode choke function. The transformer element L_{CM,SRC} can be disposed between a primary side full bridge 410 composed of the third switching element Q_{3,SRC} and the fourth switching element Q_{4,SRC} and a secondary side bridge 430 composed of four switching elements D_{1,SRC}, D_{2,SRC}, D_{3,SRC}, and D_{4,SRC}.

The common mode choke can function to decrease a high-frequency common mode current, and the larger an inductance value, the higher the performance of decreasing the common mode current. Because the transformer element L_{CM,SRC} can have a large inductance value of hundreds of Mh, the performance of decreasing common mode noise can be secured.

An output capacitor C₀₁ can be disposed in the output side full bridge 430.

The output filter unit 440 can function as a filter so that a constant DC current flows through an output load Ro. A current i_{REC} of the output side full bridge 430 can have a waveform that rectifies the AC resonance current of the resonant transformer 420 to a positive value. Therefore, the output filter unit 440 can send only a constant average current of the current i_{REC} to the output load R₀.

The output filter unit 440 can include two first and second output Y-capacitors C_{Y1,0} and C_{Y2,0} connected in series, a transformer element L_{CM,out} connected parallel to the first and second output Y-capacitors C_{Y1,0} and C_{Y2,0}, a second output capacitor C₀₂ connected parallel to the transformer element L_{CM,out}, and third and fourth output Y-capacitors C_{Y3,0} and C_{Y4,0} connected parallel to the second output capacitor C₀₂ and connected in series.

The transformer element L_{CM,out} can function as a filter for filtering common mode noise as the inductance decreases the common mode (CM) current generated in the circuit.

A voltage V_{CY10} can be generated from the third output Y-capacitor C_{Y3,0}, and a voltage V_{CY20} can be generated from the fourth output Y-capacitor C_{Y4,0}.

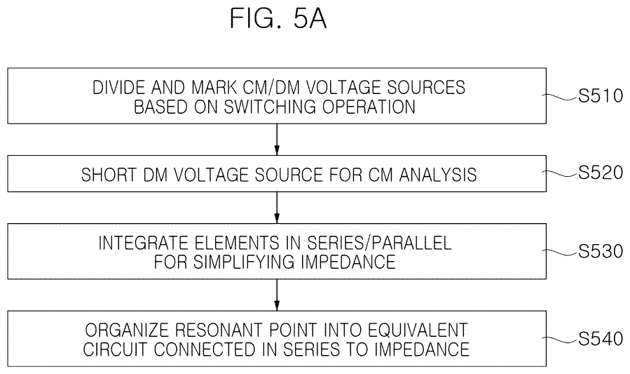

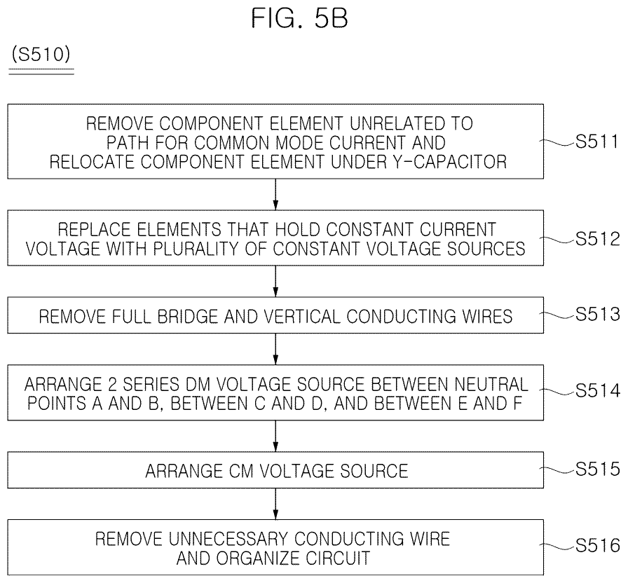

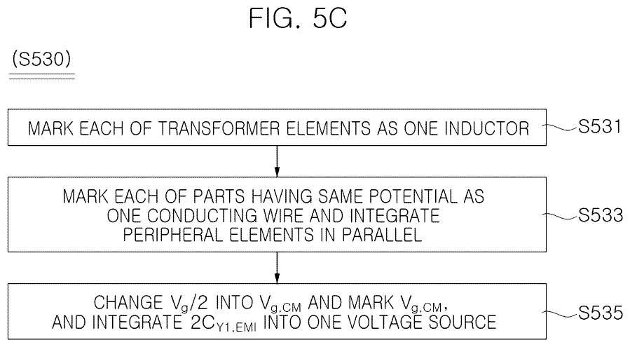

FIG. 5A is a flowchart showing a process of generating a common mode equivalent circuit according to an embodiment of the present disclosure. Referring to FIG. 5A, in the circuit diagram of the charger 120, a switching operation-based CM voltage source and a differential mode (DM) voltage source are separately shown (operation S510).

The CM can be a term used to represent noise, but in some cases, means that a current flows in the same direction at plus and minus sides of a power supply. The DM can be a term used to represent noise, but in some cases, can be also used to represent a current or voltage that transmits power. In an embodiment of the present disclosure, the DM can be used to mean transmitting power.

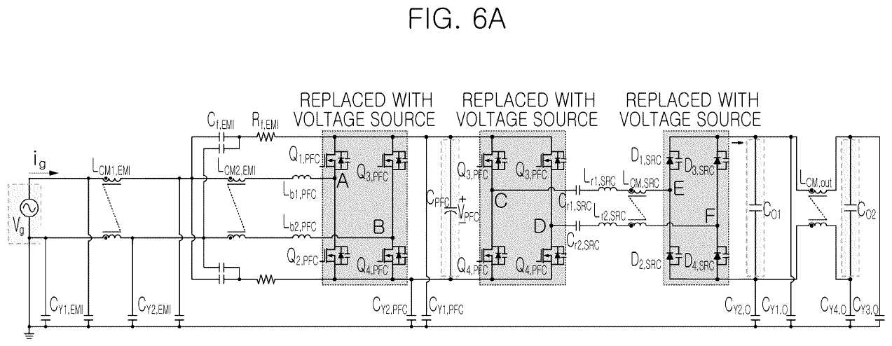

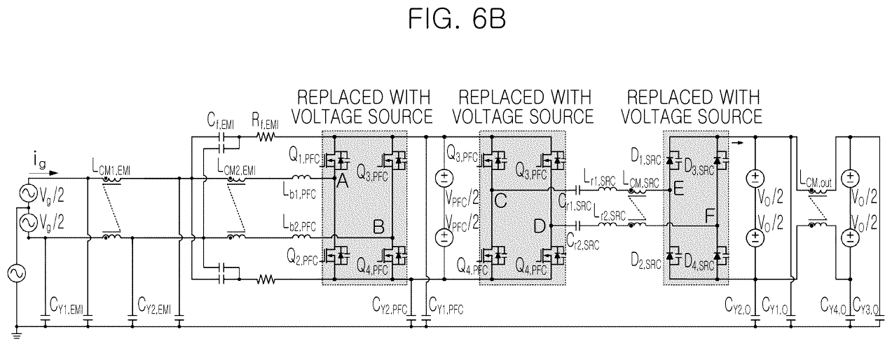

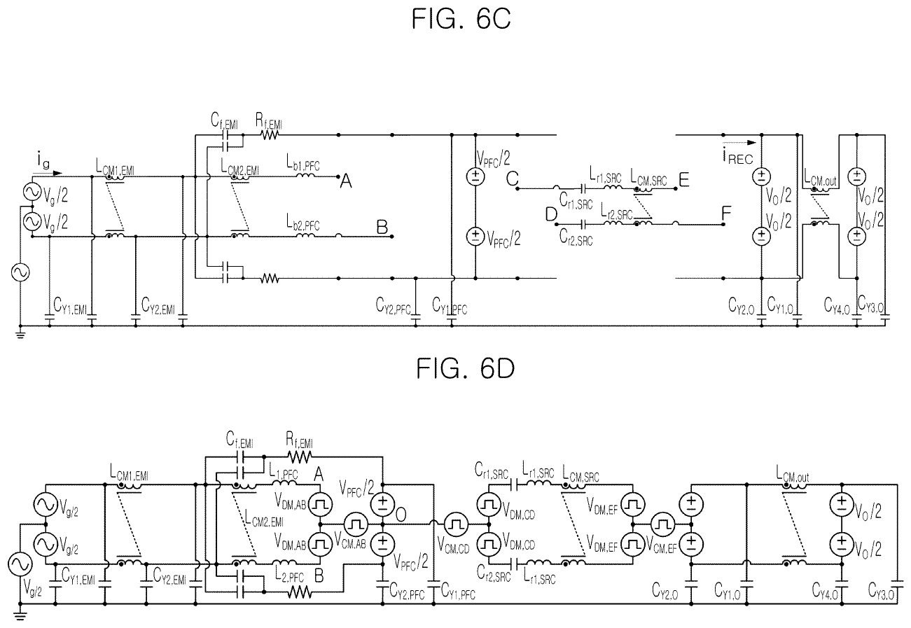

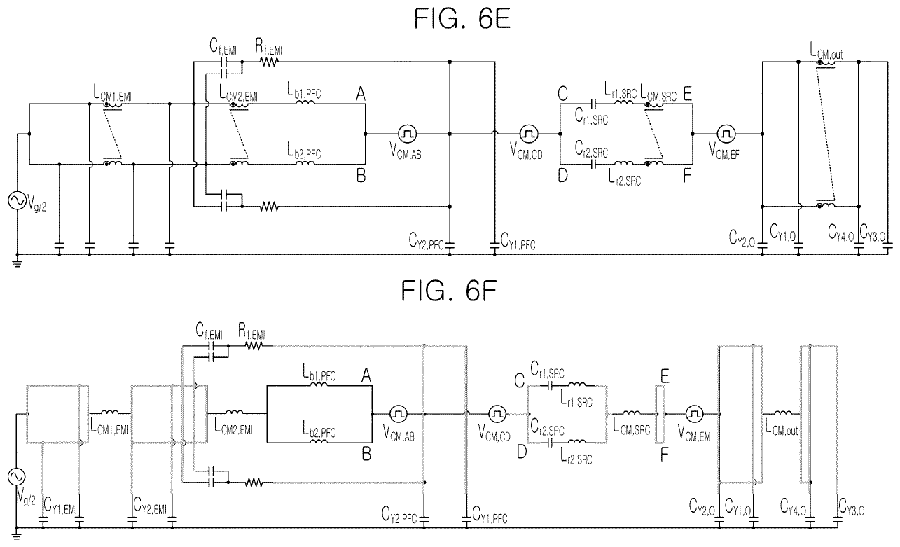

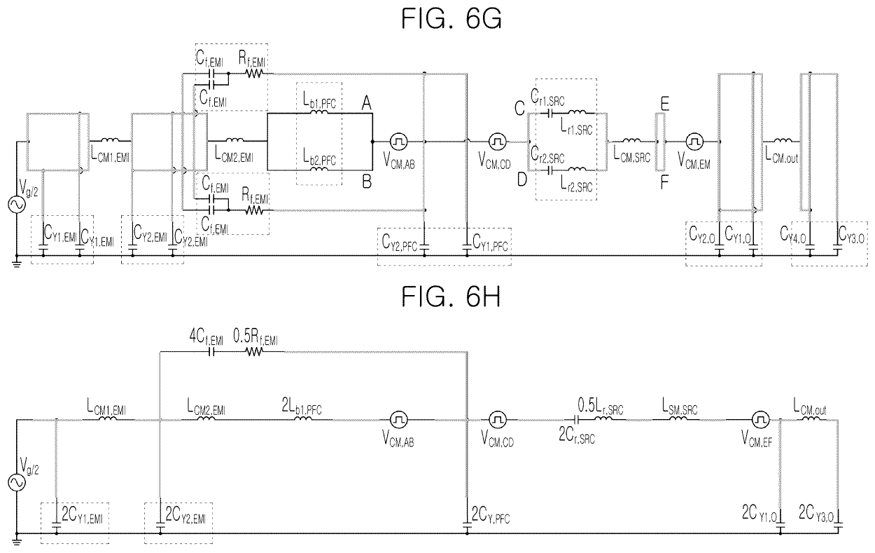

Then, the DM voltage source can be shorted for CM analysis (operation S520). That is, it can be to constitute an equivalent circuit and analyze a CM voltage using the equivalent circuit. Therefore, the DM voltage source can be not a cause of the CM current, so can be shorted (i.e., considered as a conducting wire). FIG. 6E shows this as an example. This will be described below.

Then, elements are integrated in series/parallel to simplify impedance (operation S530).

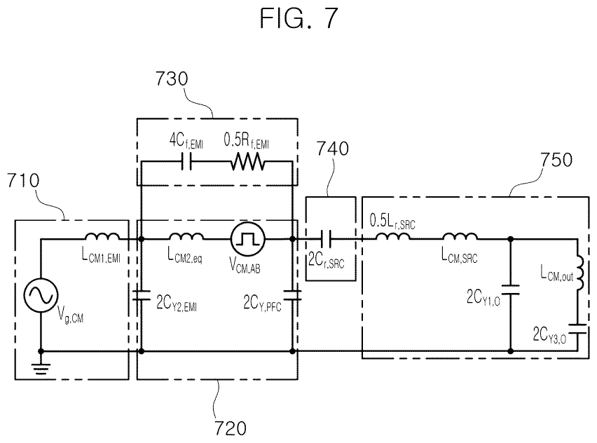

Then, a resonance point can be organized into an equivalent circuit connected in series to output impedance (operation S540). FIG. 7 shows this as an example. FIG. 7 will be described below.

FIG. 5B is a flowchart showing a detailed process of operation S510 of separately indicating voltage sources shown in FIG. 5A. Referring to FIG. 5B, component elements unrelated to the path of the CM current can be removed and relocated under the Y capacitor (operation S511). FIG. 6A shows this as an example. This will be described below.

Then, elements that maintain a constant current voltage can be replaced with a plurality of constant voltage sources (operation S512). FIG. 6B shows this as an example. This will be described below.

Then, the full bridge and vertical conducting wires can be removed (operation S513). FIG. 6C shows this as an example. This will be described below.

Then, two serial DM voltage sources can be disposed between the neutral points A and B, between C and D, and between E and F, and the CM voltage source can be disposed (operations S514 and S515).

Then, unnecessary conducting wires are removed and the circuit can be organized (operation S516). FIG. 6D shows this as an example. This will be described below.

FIG. 5C is a flowchart showing a detailed process of operation S530 of integrating the voltage sources shown in FIG. 5A in series and parallel. Referring to FIG. 5C, the transformer elements L_{CM1,EMI}, L_{CM2,EMI}, L_{CM,SRC}, and L_{CM,out} can be each marked with one inductor (operation S531). FIG. 6F shows this as an example. This will be described below.

Then, components having the same potential can be each marked with one conducting wire, and peripheral elements can be integrated in parallel (operation S533). FIG. 6G shows this as an example. This will be described below.

Then, a voltage source V_{g}/2 can be marked by being changed to V_{g,CM}, and 2_{CY1,EMI} can be integrated into one voltage source (operation S535). FIG. 6F shows this as an example. This will be described below.

FIGS. 6A to 6H are circuit diagrams showing a process of changing all circuit diagrams according to FIGS. 2 to 4 into equivalent circuits. Before describing FIGS. 6A to 6H, in the equivalent circuit modeling, the following rules can be followed.
\textcircled{1} A switching element and a diode can be replaced with a voltage source generated according to on/off operations.
\textcircled{2} An input AC voltage can be marked by being divided into a CM voltage source and a DM voltage source.
\textcircled{3} Elements through which a CM current flows can be left or integrated.
\textcircled{4} The remaining elements can be replaced with a voltage source, integrated, or removed in some cases.

In the entire circuit diagram according to FIGS. 2 to 4, the AC voltage source Vᵢₙ can be replaced with a grid voltage source V_{g}, the capacitors C_{DM,EMI}, 201, and 301 and the output load R₀ can be removed, and the remaining capacitors C_{Y1,EMI}, C_{Y2,EMI}, C_{Y1,PFC}, C_{Y2,PFC}, C_{Y1,0}, C_{Y2,0}, C_{Y3,0}, and C_{Y4,0} can be relocated under the Y capacitor, thereby becoming the circuit diagram of FIG. 6A. That is, the capacitors C_{DM,EMI}, 201, and 301 and the output load R₀ do not become a path for a CM current i_{g}. That is, the CM current i_{g} does not flow.

Therefore, the capacitors C_{DM,EMI}, 201, and 301 and the output load R₀ have nothing to do with the CM current and have a small capacitor of several nF, so may be removed from the CM equivalent modeling. The output load R₀ may be removed because it is not the path for the CM current.

The capacitor C_{PFC} of the output unit 330 of the power factor adjustment circuit 122 and the capacitors C₀₁ and C₀₂ of the output filter unit 440 of the converter 123 may not be the path for the CM current, but have a sufficiently large capacitor from hundreds of nF to hundreds of uF and function to hold a constant DC voltage.

Therefore, these components are not removed, but replaced with a constant voltage source. These components may be replaced with a simple single voltage source, but for the convenience of the CM equivalent modeling, are replaced with two ‘series capacitor voltage sources V_{PFC}/2 and V₀/2)’ each having half the size. FIG. 6B shows this as an example.

Referring to FIG. 6B, the AC voltage source a) functions as a power source for a charger and b) also causes a leakage current because the bottom of the AC voltage source is connected to GND. Therefore, for the convenience of the CM equivalent modeling, the AC voltage source at the input side is marked as two ‘series AC input voltage sources V_{g}/2’ each having half the size, and an AC voltage (one of the CM voltage sources) having half the size is marked by being added between the midpoint of the two.

Referring to FIG. 6C, the circuit diagram in FIG. 6C shows a state in which the full bridges are deleted and vertical conducting wires are removed from FIG. 6B.

Referring to FIG. 6D, the circuit diagram shown in FIG. 6D shows a state in which the CM voltage source and the DM voltage source are disposed between the first neutral point A and the second neutral point B, between the third neutral point C and the fourth neutral point D, and between the fifth neutral point E and the sixth neutral point F in FIG. 6C.

That is, the DM voltage source is first disposed between the first neutral point A and the second neutral point B, between the third neutral point C and the fourth neutral point D, and between the fifth neutral point E and the sixth neutral point F.

One voltage generated by the on/off operations of a switch or a diode is present between the first neutral point A and the second neutral point B, between the third neutral point C and the fourth neutral point D, and between the fifth neutral point E and the sixth neutral point F.

The shape or waveform of the voltage is not important. However, as described above, for the convenience of the CM equivalent modeling, these voltages are marked as two ‘series switching DM voltage sources’ each having half the size of the CM voltage source. The two ‘series switching DM voltage sources V_{DM,AB}, V_{DM,CD} and V_{DM,EF}’ function to transmit power to the output side of the charger. Voltages transmitting power are DM voltages, so are marked with the subscript DM.

The CM voltage source V_{CM,AB}, V_{CM,CD}, and V_{CM,EF} are disposed between a ‘midpoint of the series switching DM voltage sources V_{DM,AB}, V_{DM,CD}, and V_{DM,EF}’ and a ‘midpoint of the series capacitor voltage sources V_{PFC}/2 and V₀/2’ and are voltages generated between these midpoints. The CM voltage source is the voltage that causes the CM current and is unrelated to power transmission.

The circuit diagram of FIG. 6D is a state of being organized by removing unnecessary conducting wires after arranging the CM voltage source and the DM voltage source.

Referring to FIG. 6E, because what is of interest is the CM current, the DM voltage source that may not cause the CM current in FIG. 6D is shorted (i.e., considered as a conducting wire) to become the circuit diagram shown in FIG. 6E. The two series capacitor voltage sources and the two series AC input voltage sources are also shorted.

Referring to FIG. 6F, each of the transformer elements L_{CM1,EMI}, L_{CM2,EMI}, L_{CM,SRC}, and L_{CM,out} in FIG. 6E is replaced with one inductor to become the circuit diagram shown in FIG. 6F. That is, the transformer elements L_{CM1,EMI}, L_{CM2,EMI}, L_{CM,SRC}, and L_{CM,out} have the same meaning as the mutual inductance of the transformer, so may be marked as one inductor. Therefore, the two conductors located at the left and right of the inductor may be marked by being grouped as one point.

Referring to FIG. 6G, elements corresponding to the same potential (i.e., one conducting wire) may be grouped. That is, parts having the same potential are marked with one conducting wire, and peripheral elements are integrated in parallel.

Referring to FIG. 6H, the elements corresponding to one conducting wire in FIG. 6G are connected in parallel to become the circuit diagram shown in FIG. 6H. Such integration is represented as follows:
C_{Y1,EMI} two parallel: 2C_{Y1,EMI}
C_{Y2,EMI} two parallel: 2C_{Y2,EM}
C_{Y1,PFC} & C_{Y2,PFC} parallel: 2C_{Y,PFC}
C_{Y1,0} & C_{Y2,0} parallel: 2C_{Y1,0}
C_{Y3,0} & C_{Y4,0} parallel: 2C_{Y3,0}
L_{b1,PFC} & L_{b2,PFC} parallel: 2L_{b1,PFC}
(C_{r1,SRC}+L_{r1,SRC}) & (C_{r2,SRC}+L_{r2,SRC}) parallel: 2C_{r1,SRC}+0.5L_{r1,SRC}
C_{f,EMI} 4 parallel: 4C_{f,EMI}
R_{f,EMI} 2 parallel: 0.5R_{f,EMI}.

In FIG. 6H, the series AC input voltage source V_{g}/2 is marked by being changed into a CM input voltage source V_{g,CM}, and the Y-capacitor 2C_{Y1,EMI} for preventing electromagnetic waves is connected parallel to the CM input voltage source V_{g,CM}, so is integrated as one voltage source. The CM voltage source V_{CM,CD} between the neutral points C and D and the CM voltage source V_{CM,EF} between the neutral points E and F are omitted because the CM voltage is not generated due to the nature of the SRC operation. Finally, the filter side inductor L_{CM2,EMI} and the power factor adjustment circuit side inductor 2L_{b1,PFC} are connected in series, so are combined and replaced with one CM equivalent inductor L_{CM2,eq}. FIG. 7 shows the result accordingly as an example.

FIG. 7 is an equivalent circuit diagram for all circuit diagrams according to FIGS. 2 to 4. Referring to FIG. 7, the equivalent circuit (i.e., the CM equivalent circuit) may include a CM voltage source block 710 that supplies a CM current, a power factor adjustment block 720 connected to the CM voltage source block 710, a floating block 730 connected parallel to the power factor adjustment block 720 to prevent sudden voltage fluctuation, a resonance block 740 for resonance, which is connected to the power factor adjustment block 720 and the floating block 730, and an output block 750 connected to the resonance block 740 to generate an output voltage according to resonance transformation, in which the output block 750 may include a resonant inductor 0.5L_{r,SRC} for an SRC, a first output Y-capacitor 2C_{Y1,0} connected parallel to the resonant inductor 0.5L_{r,SRC} for an SRC, and a CM output inductor L_{CM,out} connected parallel to the first output Y-capacitor 2C_{Y1,0}, a third output capacitor C_{Y3,0} connected in series to the CM output inductor L_{CM,out}, etc.

The CM voltage source block 710 may include the CM input voltage source V_{g},CM for supplying the CM current, and the inductor L_{CM1,EMI} for preventing electromagnetic waves, which is connected in series to the CM input voltage source V_{g,CM}.

The power factor adjustment block 720 may include a capacitor 2C_{Y2,EMI} for preventing electromagnetic waves, which is connected parallel to the CM input voltage source V_{g,CM}, a CM equivalent inductor L_{CM2,eq} connected in series to the capacitor 2C_{Y2,EMI} for preventing electromagnetic waves, a CM voltage source V_{CM,AB} between the neutral points A and B, which is connected in series to the CM equivalent inductor L_{CM2,eq}, and a power factor adjustment capacitor 2C_{Y,PFC} connected to the CM voltage source V_{CM,AB} between the neutral points A and B and a resistor 0.5R_{f,EMI} for an electromagnetic wave line filter and being parallel to the capacitor 2C_{Y2,EMI} for preventing electromagnetic waves.

The floating block 730 may include a floating capacitor 4C_{f,EMI} for filtering electromagnetic waves, which is connected parallel to the CM input voltage source V_{g,CM} and the resistor 0.5R_{f,EMI} for an electromagnetic wave line filter, which is connected to the floating capacitor 4C_{f,EMI} for filtering electromagnetic waves.

The resonance block 740 may include a resonant capacitor 2C_{r,SRC} for an SRC, which is connected in series to the CM voltage source V_{CM,AB} between the neutral points A and B.

The output block 750 may include the resonant inductor 0.5L_{r,SRC} for an SRC, which is connected in series to the resonant capacitor 2C_{r,SRC} or 740 for an SRC, the first output Y-capacitor 2C_{Y1,0} connected parallel to the resonant inductor 0.5L_{r,SRC} for an SRC, the CM output inductor L_{CM,out} connected parallel to the first output Y-capacitor 2C_{Y1,0}, and the third output capacitor C_{Y3,0} connected in series to the CM output inductor L_{CM,out}.

Referring to FIG. 7, the resonant capacitor is connected in series to the output side impedance.

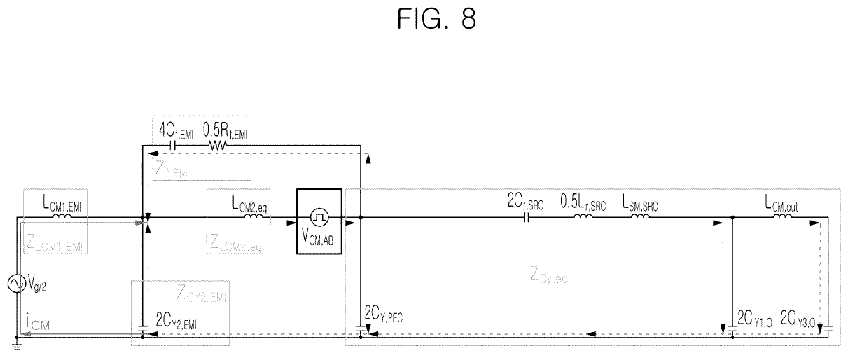

FIG. 8 is a diagram showing the impedance of the equivalent circuit shown in FIG. 7. Referring to FIG. 8, the CM leakage current i_{CM} is generated by the CM noise voltage V_{CM,AB}, and a transfer function G_{CM} from the CM noise voltage V_{CM,AB} to the CM leakage current i_{CM} is calculated as follows in Equations 5 and 6.

$${G}_{CM} = \frac{1}{{Z}_{th} + {Z}_{{L}_{CM 1} , EMI}} \cdot \frac{{Z}_{f , EMI} {Z}_{{C}_{Y 2} , EMI}}{{Z}_{f , EMI} ( {Z}_{Cy , eq} + {Z}_{{C}_{Y 2} , EMI} ) + {Z}_{{L}_{CM 2} , eq} ( {Z}_{f , EMI} + {Z}_{Cy , eq} + {Z}_{{C}_{Y 2} , EMI} )} \qquad [ Equation 5 ]$$

$${Z}_{th} = \frac{{Z}_{f , EMI} \cdot {Z}_{{L}_{CM 2} , eq} \cdot {Z}_{{C}_{Y 2} , EMI} + {Z}_{{C}_{Y 2} , EMI} \cdot {Z}_{Cy , eq} \cdot ( {Z}_{f , EMI} + {Z}_{{L}_{CM 2} , eq} )}{{Z}_{f , EMI} \cdot {Z}_{{L}_{CM 2} , eq} + ( {Z}_{Cy , eq} + {Z}_{{C}_{Y 2} , EMI} ) \cdot ( {Z}_{f , EMI} + {Z}_{{L}_{CM 2} , eq} )} \qquad [ Equation 6 ]$$

Variables can be defined as follows in Table 1.

TABLE 1

| Parameters | Definition |
|---|---|
| Z_{LCM1, EMI} | Impedance of L_{CM1, EMI} |
| Z_{CY2, EMI} | Impedance of 2C_{Y1, EMI} |
| Z_{f, EMI} | Impedance of 4C_{f, EMI} + 0.5R_{f, EMI} |
| Z_{LCM2, eq} | Impedance of L_{CM2, eq} |
| Z_{Cy, eq} | Integrated equivalent impedance of 2C_{Y, PFC}, 2C_{r, SRC}, |
| | 0.5L_{r, SRC}, L_{CM, SRC}, 2C_{Y1, O}, L_{CM, out}, 2C_{Y3, O} |
| Zₜₕ | Integrated thevenin equivalent impedance of Z_{f, EMI}, |
| | Z_{LCM2, eg}, Z_{Cy, eq} |

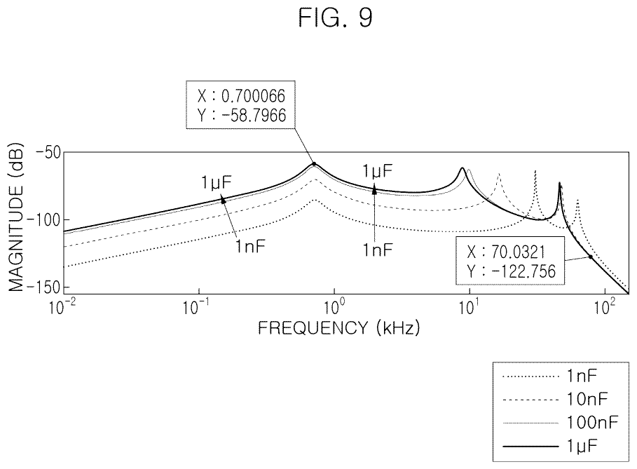

FIG. 9 is a transfer function bode plot according to an embodiment of the present disclosure. Referring to FIG. 9, the smaller the gain of the transfer function G_{CM} bode plot, the smaller the CM leakage current i_{CM}, so it can be important to secure a low gain of the transfer function G_{CM}.

Generally, the resonant capacitor of the SRC stage can be designed to be several tens of nF. That is, values according to the parameters can be as follows in Table 2.

TABLE 2

| Parameters | Value | |
|---|---|---|
| C_{Y1, EMI}/C_{Y2, EMI} | 4.7 | nF |
| L_{CM1, EMI}/L_{CM2, EMI} | 2 mH/20 mH | |
| C_{f, EMI} | 1 | μF |
| R_{f, EMI} | 27 | Ω |
| C_{Y1, PFC}/C_{Y2, PFC} | 0.47 | nF |
| C_{r1, SRC}/C_{r2, SRC} | 30 | nF |
| L_{r1, SRC}/L_{r2, SRC} | 45 | μH |
| L_{CM, SRC}/L_{CM, out} | 3 mH/0.65 mH | |
| C_{Y1, O}/C_{Y2, O} | 0.47 | nF |

| | |
|---|---|
| C_{Y3, O}/C_{Y4, O} | 1 nF, 10 nF, 100 nF, 1 μF |

As shown in FIG. 9, because the resonant capacitor is connected in series to the output side impedance, even when the output Y-cap increases to several uF, the gain of the transfer function may maintain a low gain that converges at a constant value. That is, it can be seen that higher reduction performance than before is exhibited and the gain curve converges.

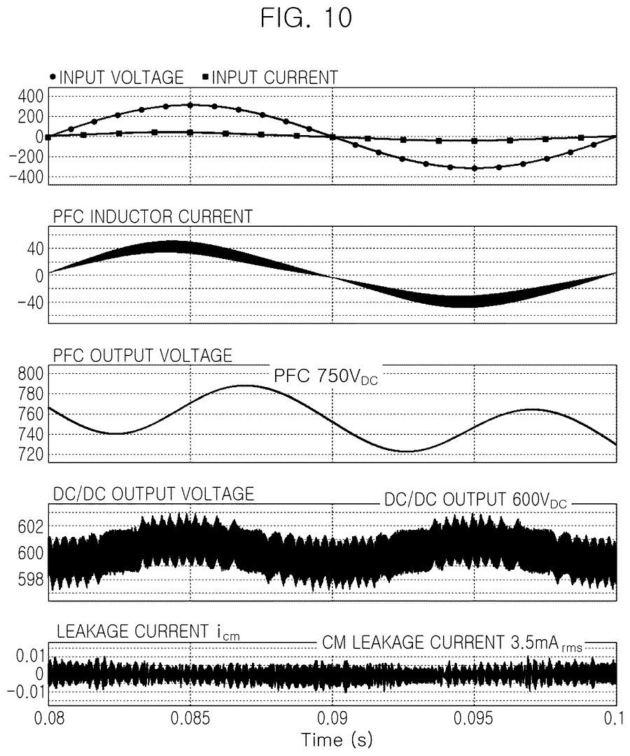

FIG. 10 is a simulation waveform diagram of a non-insulated charger according to an embodiment of the present disclosure. Referring to FIG. 10, main parameters of simulation can be as follows in Tables 3 and 4.

TABLE 3

| Parameters | Value | |
|---|---|---|
| V_{g} | 220 | V_{ac} |
| Grid frequency | 50 | Hz |
| V_{PFC}/V_{O} | 750 V/600 V | |
| L_{b1, PFC}/L_{b2, PFC} | 92 μH/92 μH | |
| C_{PFC} | 500 | μF |

| | |
|---|---|
| L_{r1, SRC}/L_{r2, SRC} | 45 μH/45 μH |
| C_{r1, SRC}/C_{r2, SRC} | 30 nF/30 nF |
| C_{O1}/C_{O2} | 2.5 μF/2.5 μF |

TABLE 4

| Parameters | Value | |
|---|---|---|
| C_{Y1, EMI}/C_{Y2, EMI} | 4.7 nF/4.7 nF | |
| L_{CM1, EMI}/L_{CM2, EMI} | 2 mH/26 mH | |
| C_{f, EMI}/R_{f, EMI} | 1 μF/27 Ω | |
| C_{Y1, PFC}/C_{Y2, PFC} | 1 nF/1 nF | |
| L_{CM, SRC} | 3 | mH |
| C_{Y1, O}/C_{Y2, O} | 1 μF/1 μF | |
| L_{CM, out} | 0.65 | mH |

| | |
|---|---|
| C_{Y3, O}/C_{Y4, O} | 1 μF/1 μF |

The GFCI leakage current cutoff standard is generally 5 mA, but the simulation result is 3.55 mA. Therefore, it can be seen that the normal charging operation of the high-voltage battery can be guaranteed due to the small leakage current.

The operations of the method or algorithm described in relation to the above-described example embodiments may be implemented in the form of program commands that may be executed through various computer devices such as a microprocessor, a processor, and a CPU and stored in a computer-readable storage medium such as memory. The computer-readable storage medium may include program (command) codes, data files, data structures, etc. alone or in combination.

What is claimed is:

1. A non-insulated charger for reducing a leakage current, comprising:
a filter configured to remove interference electromagnetic waves from an AC voltage;
a power factor adjustment circuit configured to reduce power loss through power factor adjustment with respect to the AC voltage from which the interference electromagnetic waves have been removed and convert the AC voltage into a first DC voltage; and
a converter configured to convert the first DC voltage into a second DC voltage differing from the first DC voltage and having a circuit structure in which both an input side and an output side have a form of a full bridge to reduce a common mode leakage current.

2. The charger of claim 1, wherein the converter comprises:
an input side full bridge configured to convert the first DC voltage into a first AC voltage;
a resonant transformer configured to convert the first AC voltage into a second AC voltage differing from the first AC voltage through a resonant circuit; and
an output side full bridge configured to convert the second AC voltage into the second DC voltage.

3. The charger of claim 2, wherein the charger is configured such that, in response to a switching frequency of the input side full bridge being same as a resonant frequency of the resonant circuit, an output voltage of the output side full bridge is same as an input voltage of the input side full bridge.

4. The non-insulated charger of claim 2, wherein the charger is configured such that as a difference between a switching frequency of the input side full bridge and a resonant frequency of the resonant circuit is greater, an output voltage of the output side full bridge is lower.

5. The charger of claim 2, wherein the resonant circuit has a resonant capacitor and a resonant inductor connected in series.

6. The charger of claim 5, wherein the resonant capacitor is directly connected to a neutral point of the input side full bridge.

7. The charger of claim 2, wherein the resonant transformer includes a transformer element connected in series to the resonant circuit, and the transformer element is configured to have a filter function of filtering common mode noise.

8. The charger of claim 1, wherein the filter, the power factor adjustment circuit, and the converter are marked as a common mode equivalent circuit.

9. The charger of claim 8, wherein the common mode equivalent circuit comprises:
a common mode voltage source block that is configured to supply a common mode current;
a power factor adjustment block connected to the common mode voltage source block;
a floating block connected parallel to the power factor adjustment block and configured to prevent sudden voltage fluctuation;
a resonant block configured to provide resonance, which is connected to the power factor adjustment block and the floating block; and
an output block connected to the resonant block and configured to generate an output voltage according to resonance transformation.

10. The charger of claim 9, wherein the common mode voltage source block comprises:
a common mode input voltage source configured to supply the common mode current, and
an inductor configured for preventing electromagnetic waves, which is connected in series to the common mode input voltage source; and
wherein the floating block comprises:
a floating capacitor configured for filtering electromagnetic waves connected in parallel to the common mode input voltage source, and
a resistor configured for an electromagnetic wave line filter, which is connected to the floating capacitor and configured for filtering electromagnetic waves.

11. The charger of claim 10, wherein the power factor adjustment block comprises:
a capacitor configured for preventing electromagnetic waves, which is connected parallel to the common mode input voltage source;
a common mode equivalent inductor connected in series to the capacitor and configured for preventing electromagnetic waves;
a common mode voltage source between neutral points, which is connected in series to the common mode equivalent inductor; and
a power factor adjustment capacitor connected to the common mode voltage source between the neutral points and the resistor for the electromagnetic wave line filter and being parallel to the capacitor and configured for preventing electromagnetic waves.

12. The charger of claim 11, wherein the resonant block comprises a resonant capacitor for a series resonant converter (SRC), which is connected in series to the common mode voltage source between the neutral points; and
wherein the output block comprises:
a resonant inductor for the SRC, which is connected in series to the resonant capacitor for the SRC,
a first output Y-capacitor connected parallel to the resonant inductor for the SRC,
a common mode output inductor connected parallel to the first output Y-capacitor, and
a third output capacitor connected in series to the common mode output inductor.

13. A method of generating an equivalent circuit of a non-insulated charger, the method comprising:
dividing, by a microprocessor, a circuit structure in a form of a full bridge into a common mode voltage source and a differential mode voltage source based on a switching operation and marking the divided circuit structure in an original circuit diagram comprising:
a filter configured to remove interference electromagnetic waves from an AC voltage,
a power factor adjustment circuit configured to reduce power loss through power factor adjustment with respect to the AC voltage from which the interference electromagnetic waves have been removed and convert the AC voltage into a first DC voltage, and
a converter configured to convert the first DC voltage into a second DC voltage differing from the first DC voltage and in which both an input side and an output side have the form of the full bridge to reduce a common mode leakage current;
shorting, by the microprocessor, the differential mode voltage source; and
integrating, by the microprocessor, certain elements in series and parallel and organizing the certain elements into a common mode equivalent circuit corresponding to the original circuit diagram.

14. The method of claim 13, wherein the dividing and marking comprises:
re-adjusting at least two elements of the certain elements unrelated to a path of a common mode current from the original circuit diagram; and
arranging the common mode voltage source and the differential mode voltage source between neutral points.

15. The method of claim 14, wherein the re-adjusting comprises:
removing a first element of the certain elements having a preset size or less among the at least two elements and relocating the first element under a Y-capacitor; and
replacing a second element of the certain elements having the preset size or more among the at least two elements with a plurality of capacitor voltage sources.

16. The method of claim 14, wherein the arranging comprises:
first arranging a plurality of differential mode voltage sources between the neutral points; and
arranging the common mode voltage source between a first midpoint of the plurality of differential mode voltage sources and a second midpoint of a plurality of capacitor voltage sources.

17. The method of claim 16, wherein a size of at least one of the differential mode voltage sources is half that of the common mode voltage source.

18. The method of claim 13, wherein the organizing of the certain elements into the common mode equivalent circuit comprises:
replacing each transformer element configured in the filter, the power factor adjustment circuit, and the converter with one inductor so as to one-to-one correspond to the inductor;
grouping two conducting wires located at a left and right of the inductor into one point and marking the two conducting wires as one conducting wire; and
integrating peripheral elements corresponding to the one conducting wire in parallel.

19. The method of claim 18, wherein the organizing of the certain elements into the common mode equivalent circuit includes:
changing a series AC input voltage source into a common mode input voltage source to mark the common mode input voltage source, and integrating a Y-capacitor configured for preventing electromagnetic waves into one voltage source;
omitting a first common mode voltage source between first neutral points;
omitting a second common mode voltage source between second neutral points; and
replacing a filter side inductor and a power factor adjustment circuit side inductor with one common mode equivalent inductor.
